(19) United States
(12) Patent Application Publication
(10) Pub. No.: US 2007/0033434 A1
(43) Pub. Date: Feb. 8, 2007

(54) Fault-tolerant processing path change management

(75) Inventor: Mihai Costea, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/199,474

(22) Filed: Aug. 8, 2005

(51) Int. Cl. G06F 11/00

(52) U.S. Cl. 714/11

(57) ABSTRACT

Change management of data processing paths by tentatively trying proposed alternative data processing path(s) without first giving up the existing processing path. If the alternative data processing path(s) does not give a more satisfactory result that the existing processing path, the existing processing path may be returned to. On the other hand, if any of the alternative processing path(s) do give a more satisfactory result, the alternative processing path may become permanent. The processing may be substantially automated.

### BACKGROUND

Computing technologies have transformed our world. While computing tools have significantly improved productivity, and our ability to communicate and learn, they also have ever increasing complexity. For example, a single corporate network may have numerous interconnected computing systems, each with different software and configuration settings.

Upgrading or otherwise installing new software into such complex systems can often cause unintended consequences, even with great effort to debug the upgrade software prior to shipment. For example, even if anti-spyware software is tested prior to shipment, the pre-shipment environment in which the anti-spyware is tested simply cannot be identical to the post-shipment environment in which the anti-spyware is used due to the complexity and diversity of many corporate systems. It could be that there is a unique feature in the post-shipment environment that has a significant effect on the performance of the anti-spyware. The state of a mere single configuration setting in a post-shipment system could be significant enough to cause less than optimal performance after upgrade. In some circumstances, the upgrade with new software may even degrade the overall performance of the existing system.

After installing an upgrade into a corporate system, it may take considerable time to identify any incorrectly set configuration settings, or other unique situations that are degrading performance, so that more optimal performance is achieved. In some cases, optimal performance may not even be achievable due to some permanent feature of the corporate system. The upgrade may, in a few cases, be so less than optimal, that it would be preferable to return the system to its state prior to the upgrade without performing the upgrade at all.

### BRIEF SUMMARY

The principles of the present invention relate to change management of processing paths by tentatively trying proposed alternative data processing path(s) without first giving up the existing processing path for the data. If the alternative data processing path(s) does not give a more satisfactory result than the existing processing path, the existing processing path may be returned to. On the other hand, if any of the alternative processing path(s) do give a more satisfactory result, the alternative processing path may become permanent, and the prior existing processing path disabled.

The data is processed simultaneously through each of the existing processing path, and the proposed alternative processing path. These processing paths are overlapping in that that there is at least one overlapping processing component that is included as part of both the existing and proposed processing paths. The processing results for each processing path may be evaluated to identify which processing path had better results. The processing path with the less satisfactory results may then be disabled.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a suitable computing system that may implement features of the present invention;

FIG. 2A illustrates a flow diagram that includes an example of an existing processing path;

FIG. 2B illustrates a flow diagram that includes an example of a proposed alternative processing path in the context of the existing processing path of FIG. 2A; and

FIG. 3 illustrates a flowchart of a method for trying alternative processing paths for data in accordance with the principles of the present invention.

### DETAILED DESCRIPTION

The principles of the present invention related to change management of data processing paths by tentatively trying proposed alternative data processing path(s) without first giving up the existing processing path. If the alternative data processing path(s) does not give a more satisfactory result than the existing processing path, the existing processing path may be returned to. On the other hand, if any of the alternative processing path(s) do give a more satisfactory result, the appropriate alternative processing path may become permanent, while disabling the existing processing path.

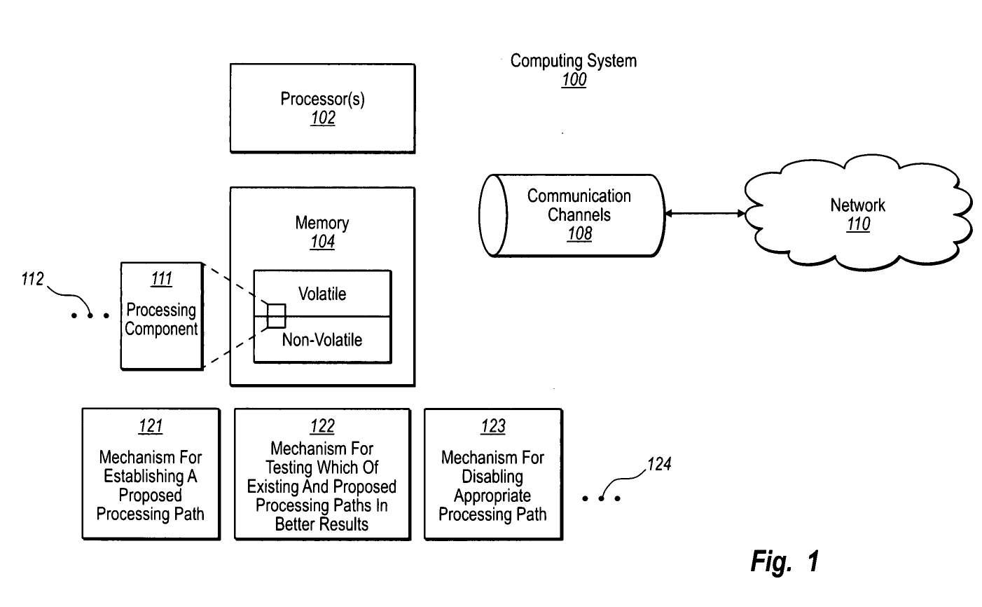

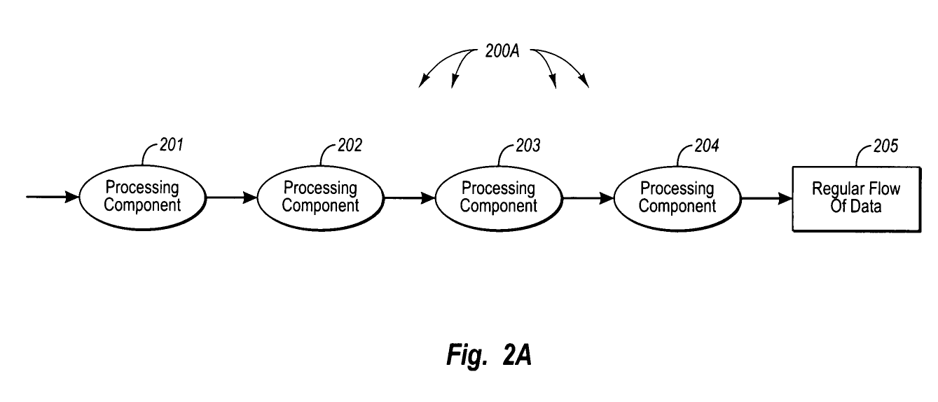

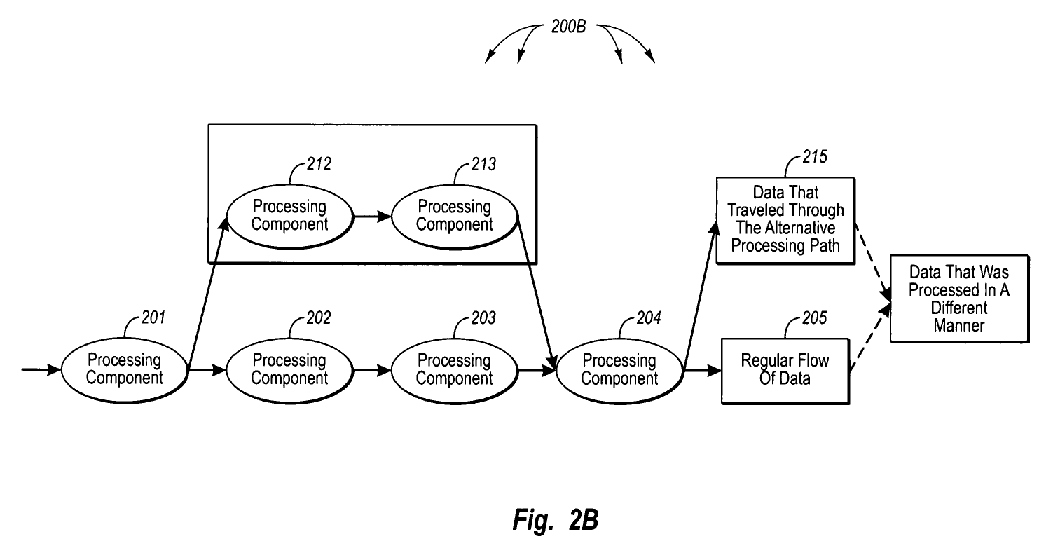

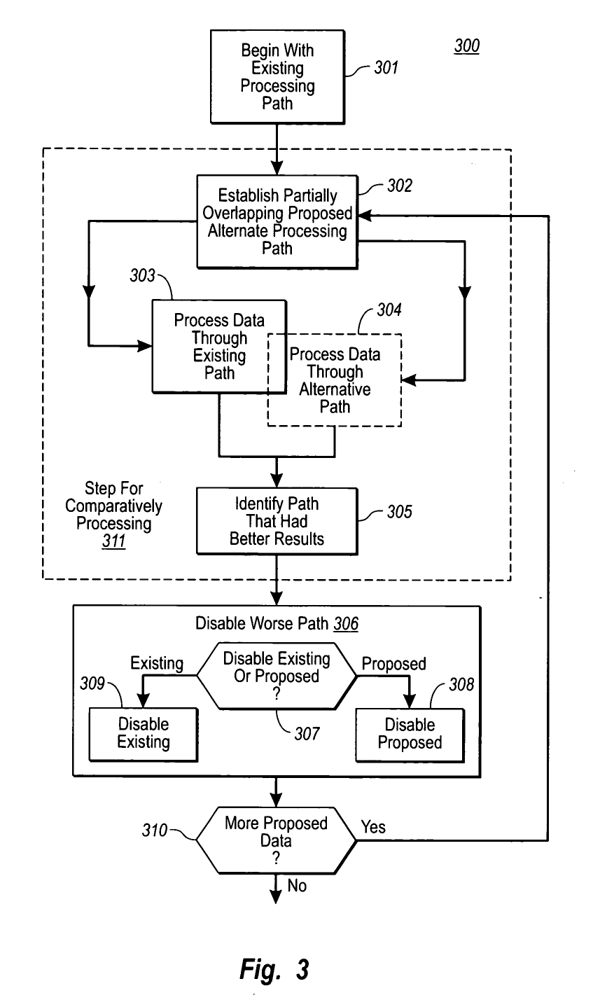

First, a general computing system will be described with respect to FIG. 1, as being a suitable computing system that may be used to practice the principles of the present invention. Then, the principles of the present invention will be described with respect to FIGS. 2A, 2B and 3.

FIG. 1 shows a schematic diagram of an example computing system 100 that may be used to implement features of the present invention. The described computing system is only one example of such a suitable computing system and is not intended to suggest any limitation as to the scope of use or functionality of the invention. Neither should the invention be interpreted as having any dependency or requirement relating to any one or combination of components illustrated in FIG. 1.

Computing systems are now increasingly taking a wide variety of forms. Computing systems may, for example, be handheld devices, appliances, laptop computers, desktop computers, mainframes, or distributed computing systems. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

Referring to FIG. 1, in its most basic configuration, a computing system 100 typically includes at least one processing unit 102 and memory 104. The memory 104 may be volatile, non-volatile, or some combination of the two. An example of volatile memory includes Random Access Memory (RAM). Examples of non-volatile memory include Read Only Memory (ROM), flash memory, or the like. The term “memory” may also be used herein to refer to non-volatile mass storage. Such storage may be removable or non-removable, and may include (but is not limited to) PCMCIA cards, magnetic and optical disks, magnetic tape, and the like.

As used herein, the term “module” or “component” can refer to software objects or routines that execute on the computing system. The different components, modules, engines, and services described herein may be implemented as objects or processes that execute on the computing system (e.g., as separate threads). While the system and methods described herein may be implemented in software, implementations in hardware, and in combinations of software and hardware are also possible and contemplated.

In the description that follows, embodiments of the invention are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

A processing component 111 is illustrated as spanning the volatile memory and non-volatile memory boundary symbolizing that the computing system is capable of either instantiating an in-memory object, or keeping the computer-executable instructions or data associated with object in non-volatile memory, or both. The processing component 111 may represent any one of the processing components illustrated with respect to FIGS. 2A and 2B.

Computing system 100 may also contain communication channels 108 that allow the computing system 100 to communicate with other computing systems over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media. The remaining components of FIG. 1 will be described in the subsequent description.

FIG. 2A illustrates a flow diagram showing an example of an existing processing path 200A that includes a series of processing components 201 through 204 that are configured to process data in series. The final result of the data is represented by the Regular Flow of Data 205 output from the final processing component 204. The number, function, and layout of the processing components within the processing path will depend on the overall function of the processing path. For example, an anti-spam processing path may include several processing components, which may include, for example, a header viewer that checks for signatures typical of spam, a content viewer checking for certain key words typical of spam, an attachment stripper that removes attachments of particular file types (e.g., executable) and the like. An anti-virus processing path may include a component that detects executables, a component that checks the executable against known viruses, attachment stripping, and the like. The processing path need not just be a series of components, but may include components that process in parallel.

Although anti-spam and anti-virus processing paths have been specifically mentioned as examples, there is no limit to the type of function accomplished by a processing path. The principles of the present invention apply to any processing path, regardless of its function. FIG. 2B illustrates a flow diagram 200B showing an example proposed alternative processing path in the context of the existing processing path of FIG. 2A, and will be described in conjunction with the method 300 of FIG. 3.

FIG. 3 illustrates a flowchart of a method 300 for tentatively trying at least one proposed alternative processing path for data without first giving up the existing processing path for the data in accordance with the principles of the present invention. The existing and proposed alternative processing paths of FIG. 2B are just one of an unlimited variety of processing paths that the principles of the present invention may be applied to. Nevertheless, the existing and proposed alternative processing paths of FIG. 2B are suitable for describing how the principles of the present invention may more generally operate.

The method 300 begins with the existing processing path being established (act 301) as, for example, is the case with respect to the example processing path of FIG. 2A. The method then proceeds to a step for comparatively processing the same data through both the existing processing path and a proposed alternative processing path that partially overlaps with the existing processing path (step 311). In the illustrated embodiment, this includes corresponding acts 302 through 305, although any corresponding acts that accomplish this stated result will suffice.

Specifically, a proposed alternative processing path is established which is partially overlapping with the existing processing path (act 302). In particular, the proposed alternative processing path and the existing processing path have one or more shared processing components. For instance, referring to FIG. 2B, processing components 201 and 204 are shared between the existing processing path and the proposed alternative processing paths.

In the illustrated embodiment of FIG. 1, the establishment of the proposed alternative processing path may be accomplished by mechanism 121, which may be implemented in software, hardware, or a combination of software and hardware. The mechanism 121 permits for copying and branching of data where a shared processing component (such as component 201 of FIG. 2B) branches into different processing components (such as components 202 and 212 of FIG. 2B) in each of the existing and proposed processing paths. The mechanism 121 also tracks which data was processed by the existing processing path, and which data was processed by the proposed alternative processing path when the data is provided once again to a shared processing component (such as component 204 of FIG. 2B). The mechanism 121 may establish the proposed alternative processing path automatically once it is notified that an alternative processing path becomes available, such as when upgrade software is installed.

The data is then processed through the existing processing path (act 303) and the alternative processing path (act 304). As some of the processing may occur simultaneously in shared processing components, the acts 303 and 304 are shown partially overlapping in FIG. 3. For instance, in order to process data through the existing processing path, the data is first provided to processing component 201 of FIG. 2B, then to processing component 202, then to processing component 203, and finally to processing component 204, which generates result 205. Similarly, in order to process data through the proposed alternative processing path, the data is first provided to processing component 201, then branches to processing component 212, then to processing component 213, then to processing component 204, to become data 215 that was processed through the alternative processing path. The processing of the data in the processing component 201 may be performed just once for both the existing and the proposed processing paths. Similarly, if the result from processing components 203 and 213 are the same, the data may likewise be processed through the processing component 204 just once for both the existing and proposed processing paths.

The system then identifies which of the existing or proposed processing paths generates a result that is more in conformance with an ideal result (act 305). For instance, suppose the processing paths have the function of detecting spam, and placing detected spam into a junk e-mail folder, and allowing e-mail that is not detected spam into an e-mail in-box. The user could observe incoming e-mails and evaluate the performance over a period of time to see if the new processing path is better capable of detecting spam, without having an unacceptable level of non-spam being falsely detected as spam. The user could then be queried to see if he/she considers the proposed alternative processing. The results could be presented to the user showing just the differences. For instance, the system could display the messages that were considered spam using the existing processing path, but were not considered spam using the proposed alternative processing path. Similarly, the user could be displayed the messages that were not considered spam using the existing processing path, but were considered spam using the proposed alternative. The user could then decide which processing path had more desirable results.

Alternatively or in addition, the identification could be automated. For instance, a set of test e-mail could be generated, some which should be ideally detected as being spam (“spam e-mails”), and some which should be ideally detected as not being spam (“non-spam e-mails”). The system could then detect for each processing path how may spam e-mails were not detected as spam, and how many non-spam e-mails were detected as spam. The system could even weight false positive errors (a non-spam e-mail being detected as spam) heavier than false negative errors (a spam e-mail not being detected as spam). The system could even weight false negative errors depending on the type of e-mail. For instance, a parent may choose to have the system weight the non-detection of spam containing bad words or advertising illegal activity as being more severe than the non-detection of spam soliciting applications for mortgage. In the context of FIG. 1, the act of identifying (act 305) may be performed by mechanism 122, which may be software, hardware, or a combination.

The processing path identified as having less desirable results is then disabled (act 306). In the context of FIG. 1, the disabling may be performed by the mechanism 123, which may be software, hardware, or a combination. Specifically, if the proposed alternative processing path results in processing results that are less in conformance with the ideal result (“Proposed” in decision block 307), the proposed alternative processing path is disabled (act 308) while keeping the existing processing path enabled. On the other hand, if the existing processing path results in processing results that are less in conformance with the ideal result (“Existing” in decision block 307), the existing processing path is disabled (act 309) while keeping the proposed alterative processing path enabled.

If there are no more proposed alternative processing paths to be evaluated (No in decision block 310), then the process of FIG. 1 may end or continue to some other processes that are not illustrated. However, if there are more proposed alternative processing paths (Yes in decision block 310), then the step 311 and act 306 may be repeated for each additional proposed alternative processing path to be evaluated. If, however, the same data is used to test the subsequent proposed alternative processing path, there would be no need to once again process the data through the existing processing path as in act 303 unless the processing is time sensitive and could result in different results depending on the time that it was processed.

The subsequent proposed processing path may have different configuration settings that the prior tested proposed processing path, but have the same processing components. Accordingly, the principles of the present invention may be used to refine configuration settings. Alternatively or in addition, the subsequent proposed processing paths may have different processing components.

Therefore, the principles of the present invention allow for proposed new processing paths to be evaluated in the actual environment in which it may be used, while keeping the existing processing path intact in case the existing processing path should be reverted to. This gives greater certainty that an upgrade processing path will either be useful in the actual use environment, or will not be used, and substantially reduces the possibility of degrading performance through an upgrade. The process may be automated, without requiring user intervention to establish the alternative processing paths, make a judgment as to which processing path generated better results, and/or disable the processing path that resulted in worse performance.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable media having thereon computer-executable instructions for executing a method for tentatively trying at least one proposed alternative processing path for data without first giving up the existing processing path for the data, the existing processing path including a first plurality of computer-executable processing components, the method comprising the following:
an act of processing data through the existing processing path by processing the data through the first plurality of computer-executable processing components to obtain a first processing result;
an act of establishing a proposed alternative processing path including a second plurality of computer-executable processing components, wherein the existing processing path and the proposed alternative processing path are partially overlapping in that there is at least one overlapping processing component that is included as part of both the first plurality of computer-executable processing components and the second plurality of computer-executable processing components;
an act of processing the data through the proposed alternative processing path by processing the data through the second plurality of computer-executable processing components to obtain a second processing result, wherein the data is processed through each of the at least one overlapping processing components simultaneously when performing both of the acts of processing the data through the existing processing path and processing the data through the proposed alternative processing path;
an act of identifying which of the first or second processing results is more in conformance with an ideal result; and
an act of disabling whichever of the existing processing path and the proposed alternative processing path results in processing results that are less in conformance with the ideal result, while keeping the other of the existing processing path and the proposed alternative processing path enabled.

2. A computer program product in accordance with claim 1, wherein
the act of identifying comprises an act of determining that the first processing result is more in conformance with the ideal result, and
the act of disabling comprises an act of disabling the proposed alternative processing path.

3. A computer program product in accordance with claim 2, wherein the data is first data, the at least one overlapping processing component is first at least one overlapping processing component, and the proposed alternative processing path is a first proposed alternative processing path, the method further comprising:
an act of processing second data through the existing processing path by processing the data through the first plurality of computer-executable processing components to obtain a third processing result;
an act of establishing a second proposed alternative processing path including a third plurality of computer-executable processing components, wherein the existing processing path and the second proposed alternative processing path are partially overlapping in that there is a second at least one overlapping processing component that is included as part of both the first plurality of computer-executable processing components and the third plurality of computer-executable processing components;
an act of processing the second data through the second proposed alternative processing path by processing the second data through the third plurality of computer-executable processing components to obtain a fourth processing result, wherein the second data is processed through each of the at least one overlapping processing components simultaneously when performing both of the acts of processing the data through the existing processing path and processing the data through the proposed alternative processing path;
an act of identifying which of the third or fourth processing results is more in conformance with the ideal result; and
an act of disabling whichever of the existing processing path and the second proposed alternative processing path results in processing results that are less in conformance with the ideal result, while keeping the other of the existing processing path and the proposed alternative processing path enabled.

4. A computer program product in accordance with claim 3, wherein the first data is the same as the second data such that the first processing result is the same as the third processing result, and wherein the acts processing the first data through the existing processing path and processing the second data through the existing processing path are the same act.

5. A computer program product in accordance with claim 3, wherein the fourth plurality of processing components and the third plurality of processing component include the same processing components, albeit at least one of them having a different configuration setting.

6. A computer program product in accordance with claim 3, wherein the fourth plurality of processing components and the third plurality of processing components are not all the same processing components.

7. A computer program product in accordance with claim 3, wherein
the act of identifying which of the third or fourth processing results is more in conformance with the ideal result comprises an act of determining that the third processing result is more in conformance with the ideal result, and
the act of disabling whichever of the existing processing path and the second proposed alternative processing path results in processing results that are less in conformance with the ideal result comprises an act of disabling the existing processing path.

8. A computer program product in accordance with claim 3, wherein
the act of identifying which of the third or fourth processing results is more in conformance with the ideal result comprises an act of determining that the fourth processing result is more in conformance with the ideal result, and
the act of disabling whichever of the existing processing path and the second proposed alternative processing path results in processing results that are less in conformance with the ideal result comprises an act of disabling the second proposed alternative processing path.

9. A computer program product in accordance with claim 1, wherein
the act of identifying comprises an act of determining that the second processing result is more in conformance with the ideal result, and
the act of disabling comprises an act of disabling the existing processing path.

10. A computer program product in accordance with claim 1, wherein the act of identifying occurs automatically, without user intervention.

11. A computer program product in accordance with claim 1, wherein the act of establishing occurs automatically, without user intervention, and the act of disabling occurs automatically, without user intervention, at least once the act of identifying is complete.

12. A computer program product in accordance with claim 1, wherein the one or more computer-readable media are physical media.

13. A computer program product in accordance with claim 12, wherein the physical memory media is volatile memory.

14. A computer program product in accordance with claim 12, wherein the physical media is non-volatile mass storage.

15. A method for tentatively trying at least one proposed alternative processing path for data without first giving up the existing processing path for the data, the existing processing path including a first plurality of computer-executable processing components, the method comprising the following:
a step for comparatively processing the same data through both the existing processing path and a proposed alternative processing path that partially overlaps with the existing processing path; and
an act of automatically disabling whichever of the existing processing path and the proposed alternative processing path that results in a more desired processing of the data, while keeping the other of the existing processing path and the proposed alternative processing path enabled.

16. A method in accordance with claim 15, wherein the step for comparatively processing comprises:
an act of processing the date through the existing processing path by processing the data through the first plurality of computer-executable processing components to obtain a first processing result;
an act of establishing the proposed alternative processing path including a second plurality of computer-executable processing components, wherein there is at least one overlapping processing component that is included as part of both the first plurality of computer-executable processing components and the second plurality of computer-executable processing components;
an act of processing the data through the proposed alternative processing path by processing the data through the second plurality of computer-executable processing components to obtain a second processing result, wherein the data is processed through each of the at least one overlapping processing components simultaneously when performing both of the acts of processing the data through the existing processing path and processing the data through the proposed alternative processing path; and
an act of identifying which of the first or second processing results is more in conformance with an ideal result.

17. A method in accordance with claim 16, wherein
the act of identifying comprises an act of determining that the first processing result is more in conformance with the ideal result, and
the act of disabling comprises an act of disabling the proposed alternative processing path.

18. A method in accordance with claim 17, wherein the data is first data, the at least one overlapping processing component is first at least one overlapping processing component, and the proposed alternative processing path is a first proposed alternative processing path, the method further comprising:
an act of processing second data through the existing processing path by processing the data through the first plurality of computer-executable processing components to obtain a third processing result;
an act of establishing a second proposed alternative processing path including a third plurality of computer-executable processing components, wherein the existing processing path and the second proposed alternative processing path are partially overlapping in that there is a second at least one overlapping processing component that is included as part of both the first plurality of computer-executable processing components and the third plurality of computer-executable processing components;
an act of processing the second data through the second proposed alternative processing path by processing the second data through the third plurality of computer-executable processing components to obtain a fourth processing result, wherein the second data is processed through each of the at least one overlapping processing components simultaneously when performing both of the acts of processing the data through the existing processing path and processing the data through the proposed alternative processing path;
an act of identifying which of the third or fourth processing results is more in conformance with the ideal result; and
an act of disabling whichever of the existing processing path and the second proposed alternative processing path results in processing results that are less in conformance with the ideal result, while keeping the other of the existing processing path and the proposed alternative processing path enabled.

19. A method in accordance with claim 16, wherein
the act of identifying comprises an act of determining that the second processing result is more in conformance with the ideal result, and
the act of disabling comprises an act of disabling the existing processing path.

20. One or more computer-readable media having thereon the following:
an existing processing path including a first plurality of computer-executable processing components;
a mechanism for establishing a proposed alternative processing path including a second plurality of computer-executable processing components, wherein the existing processing path and the proposed alternative processing path are partially overlapping in that there is at least one overlapping processing component that is included as part of both the first plurality of computer-executable processing components and the second plurality of computer-executable processing components;
a mechanism for testing which of the existing processing paths or the proposed processing path results in a better result;
a mechanism for disabling whichever of the existing processing path and the proposed alternative processing path does not have the better result.
